(19) United States
(12) Patent Application Publication
(10) Pub. No.: US 2006/0031495 A1
(43) Pub. Date: Feb. 9, 2006

(54) Fault tolerant e-mail feature for digital repository

(75) Inventors: Thomas W. Connors, Rochester, NY (US); Neeraj Wadhera, Webster, NY (US)

Correspondence Address: Kermit Lopez;ORTIZ & LOPEZ, PLLC, P.O. Box 4484, Albuquerque, NM, 87196-4484, US

(73) Assignee: Xerox Corporation

(21) Appl. No.: 10/879,907

(22) Filed: Jun. 29, 2004

(51) Int. Cl. G06F 15/173; G06F 15/16

(52) U.S. Cl. 709/225; 709/206

(57) ABSTRACT

A plurality of electronic documents can be configured such that one or more of the electronic documents are subject to a user-designated restriction. The plurality of electronic documents can then be selected, in response to a user input, as an attachment to an electronic message. Thereafter, the plurality of electronic documents can be automatically and electronically transmitted as an attachment to the electronic message without one or more of the electronic documents that were subject to the user user-designated restriction. In this manner a user can select an entire file and then select electronic mail features in which document permissions are established such that electronic documents which should not be accessible cannot be retrieved, but electronic mail operations can proceed in sending those documents among the group or plurality of electronic documents, which are designed as accessible.

### TECHNICAL FIELD

Embodiments are generally related to electronic mail methods and systems. Embodiments are additionally related to computer networks. Embodiments are also related to methods and systems for managing the distribution and transmission of electronic documents.

### BACKGROUND OF THE INVENTION

Electronic mail (“e-mail”) relates to the exchange of text messages and computer files over a communications network such as the well-known Internet and/or wireless communications network. E-mail users possess e-mail addresses to which e-mail can be sent and received over such communications networks. An e-mail address is essentially a string that identifies a user to that the user can receive e-mail. An e-mail address typically includes a name that identifies the user to a mail server, followed by a “@” symbol and a host name and domain name of the server.

In a conventional process of sending e-mail messages from a source client to a destination client, a source client can composes an e-mail message, which is then sent from the source client to a source simple mail transfer protocol (SMTP) server, often referred to simply as an e-mail server. The source SMTP server sends the e-mail message to a destination SMTP server 130, which then sends the e-mail message to the destination client.

In a managed digital document repository, document distribution features commonly include “zip & email,” “email document(s),” or “email URL” and other similar e-mail features. Current implementations of this feature do not attempt to send e-mail unless all of the selected documents can be accessed and the selected operation (e.g., such as “zip”) can be completed successfully. In a managed services environment, retrieval and/or inclusion of a document in the email may fail for a variety of reasons. For example, users may possess “browse” access on a document, but may not have the ability to access the document for inclusion in an e-mail distribution. In such a scenario, unless all of the selected documents can be successfully included in the e-mail operation, current e-mail related operations will fail. The user must then spend time re-selecting valid documents and re-attempting the email operation.

It is believed that a solution to such drawbacks involves implementing a configurable e-mail feature that allows the e-mail-related operation to proceed with e-mailing only those selected documents that could be successfully included. Such configurable e-mail features are disclosed and described in greater detail herein.

### BRIEF SUMMARY

It is, therefore, a feature of the present invention to provide for an improved electronic mail method and system.

It is another feature of the present invention to provide for a user configurable electronic mail method and system.

It is also a feature of the present invention to provide for improved methods and systems for transmitting and managing electronic documents.

Aspects of the present invention relate to methods and systems for configuring electronic documents for electronic transmission. A plurality of electronic documents can be configured such that one or more of the electronic documents are subject to access restrictions. The plurality of electronic documents can then be selected, in response to a user input, as an attachment to an electronic message. The email feature can be configured such that the attachment transmission may either proceed or terminate in the event that the documents selected for inclusion in the attachment cannot be included due to the document access restrictions.

Thereafter, the plurality of electronic documents can be automatically and electronically transmitted as an attachment to the electronic message without one or more of the electronic documents that were subject to the designated access restriction. In this manner a user can select an entire file and then select electronic mail features in which document permissions are established such that electronic documents which should not be accessible cannot be retrieved, but electronic mail operations can proceed in sending those documents among the group or plurality of electronic documents, which are designed as accessible.

### BRIEF DESCRIPTION OF THE DRAWINGS

The accompanying figures, in which like reference numerals refer to identical or functionally-similar elements throughout the separate views and which are incorporated in and form part of the specification further illustrate embodiments of the present invention.

FIG. 1 illustrates a block diagram of a system, which can be utilized to implement a preferred embodiment of the invention;

FIG. 2 illustrates a flow diagram depicting logical operation steps, which can be utilized to implement a preferred embodiment of the invention;

FIG. 3 illustrates an electronic document management user interface, which can be implemented in accordance with a preferred embodiment;

FIG. 4 illustrates an electronic document management user interface with high-level e-mail status information, which can be implemented in accordance with a preferred embodiment; and

FIG. 5 illustrates the electronic document management user interface, which displays detailed e-mail status information, in accordance with a preferred embodiment.

### DETAILED DESCRIPTION OF THE INVENTION

The particular values and configurations discussed in these non-limiting examples can be varied and are cited merely to illustrate embodiments of the present invention and are not intended to limit the scope of the invention.

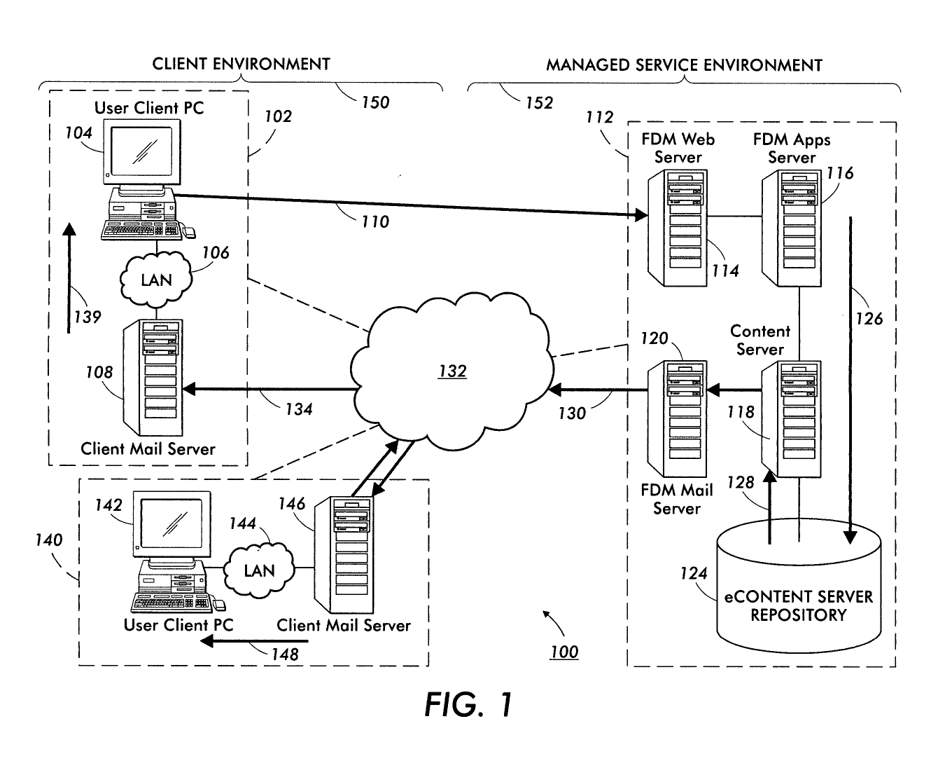

FIG. 1 illustrates a block diagram of a system 100, which can be utilized to implement a preferred embodiment of the invention. System 100 generally includes a client environment 150 and a managed service environment 152. Client environment 150 generally includes a document sender location 102 and a document receiver location 140. Management service environment 152 is generally composed of a foundation document management (FDM) platform 112. Document sender location 102 can be composed of a user's client computer 104, which can be, for example, a personal computer (PC), laptop computer, computer workstation, personal digital assistant (PDA) and the like or a combination thereof. Computer 104 can communicate with a local area network (LAN) 106, which in turn can communicate with a client mail server 108. Document receiver location 140—can include a user's client computer 142, which can be, for example, a personal computer (PC), laptop computer, computer workstation, personal digital assistant (PDA) and the like or a combination thereof. Computer 142 can communicate with a local area network (LAN) 144, which in turn can communicate with a client mail server 146.

The foundation document management platform 112 can be configured to include an FDM web server 114 that communicates with an FDM applications server 116, which in turn can communicate with a content server 118. A database 124 communicates with content server 118. Database 124 functions as an “eContent” server repository. Foundation document management platform 112 further includes an FDM mail server 120. In general, the foundation document management platform 112 can communicate with a computer network 132 (e.g., the “Internet”). Similarly, document sender location 102 and document receiver location 140 can communicate with computer network 132.

A variety of steps can be implemented within the context of system 100. A first step, as represented by arrow 110, involves a request by a user to e-mail one or more electronic documents. A second step, as indicated by arrows 126 and 130 involves an operation in which the foundation document management platform 112 retrieves electronic documents from repository or database 124 and may compress such electronic documents in a proper compressed format for e-mail transmission thereof. Note that an actual implementation of system 100 may not necessarily require the use of separate computer systems for the FDM web server 114, the FDM apps server 116, the eContent server 118, and the FDM mail server 120. All functional components may be implemented on a single computer system.

In a preferred embodiment, however, FDM mail server 120 can serve a useful purpose for the management of electronic messages and attached electronic documents from and to foundation document management platform 112. A third step, as indicated by arrows 130, 138, and 148 involves an operation in which the foundation document management platform 112 can e-mail the electronic documents as an attachment from the FDM mail server 120 to the mail server 146 associated with document receiver location 140. A fourth and final step, as indicated by arrows 136, 134 and 139 can involve an operation in which client mail server 146 of document receiver location 140 communicates any problems via e-mail to the sender's mail server 108 and ultimately to the sender's computer 104.

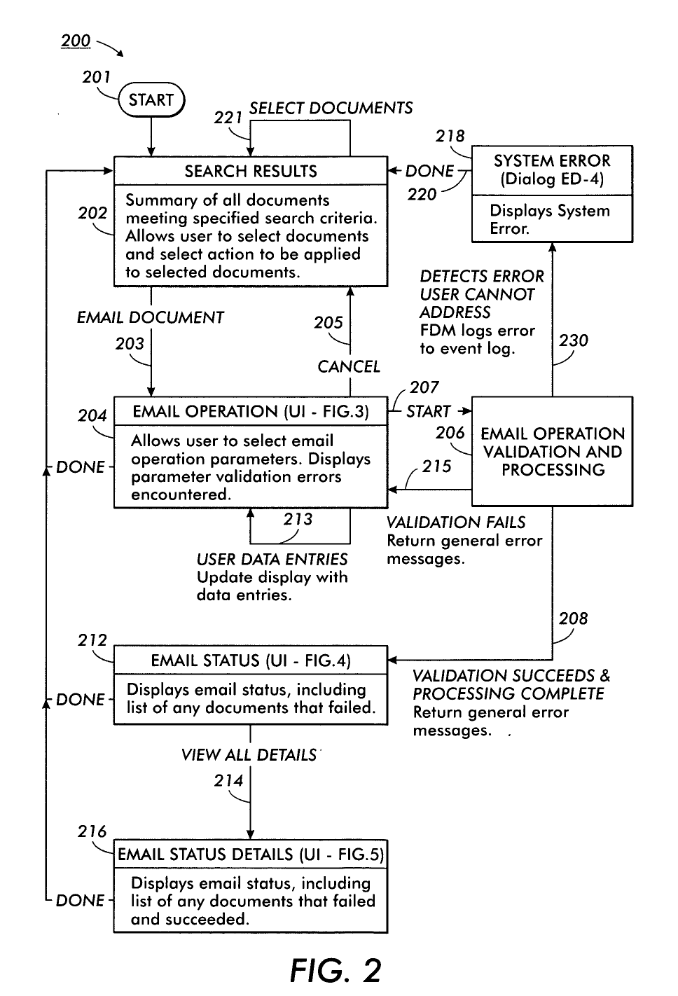

FIG. 2 illustrates a flow diagram 200 depicting logical operation steps, which can be utilized to implement a preferred embodiment of the invention. The process can be initiated, as indicated at block 201. Thereafter, as indicated at block 202, a search can be performed in which a summary of all electronic documents stored in a repository such as, for example, database 124 illustrated in FIG. 1, meeting specified search criteria is generated, in response to user input. The operation indicated at block 202 generally allows a user to select electronic documents and also to select one or more particular actions to be applied to the selected documents.

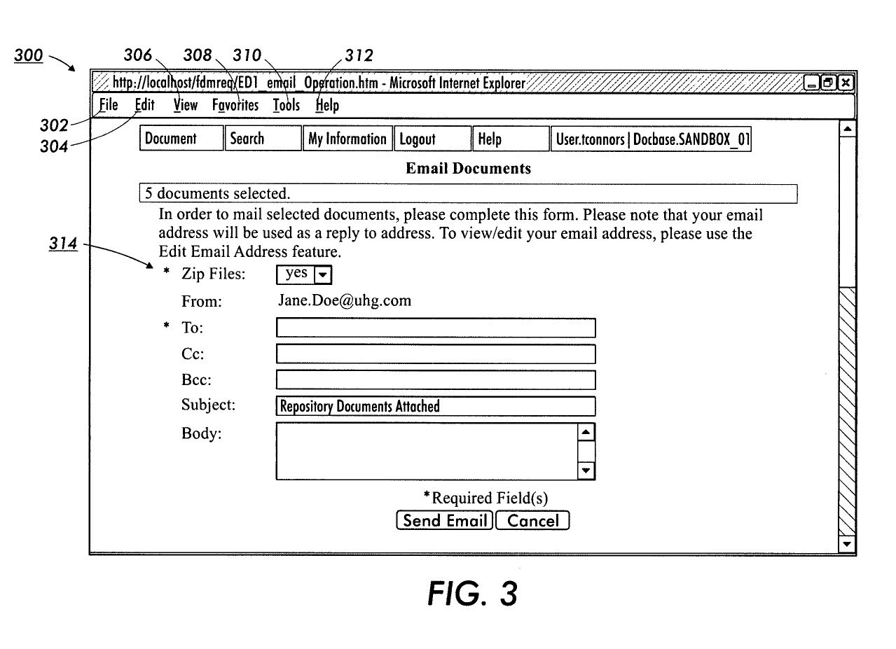

The actual selection of electronic documents is indicated by arrow 221. Thereafter, as indicated at arrow 203 and block 204, the actual e-mail operation can be implemented. As described at block 204, a user is allowed to select the e-mail operation parameters. In block 204, for example, the phrase “e-mail operation” refers to the UI (User Interface) depicted in FIG. 3. User data update entries can also be displayed for a user(s), as indicated by arrow 213. At any time during this processing, a user may cancel the e-mail operation as indicated by arrow 205. Note that a graphical user interface example of the operation described at block 204 is also shown generally in FIG. 3 as user interface 300.

Following processing of the operation depicted at block 204 the user may initiate the e-mail operation by selecting a button, for example labeled “Start,” as indicated by arrow 207. Upon user initiation of the e-mail operation, the system validates parameters and displays any validation errors, as indicated by arrow 215. After successfully validating parameters, the e-mail operation is executed. Upon completion, indicated as arrow 208, any operation general error messages can be returned along with data indicating any document related failures.

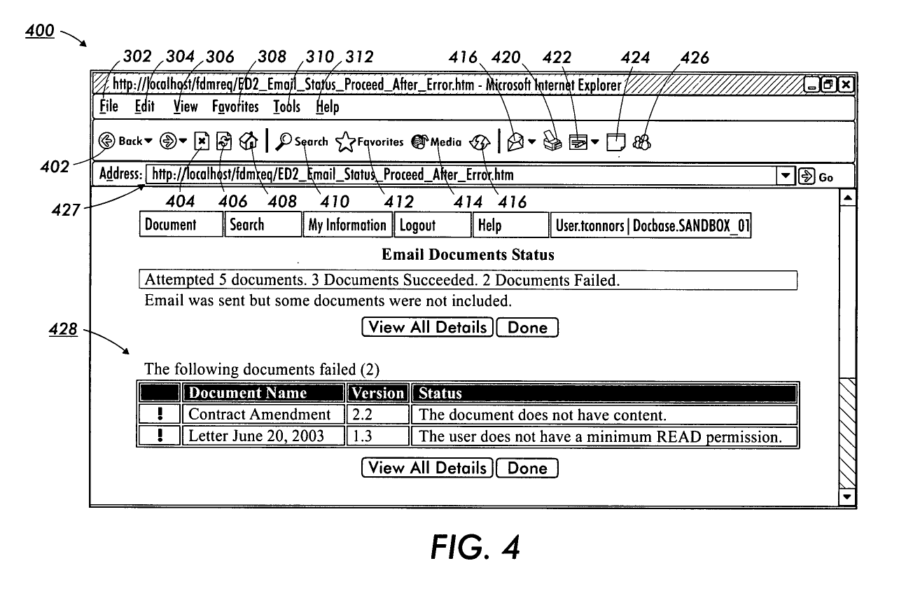

Thereafter, as indicated in block 212, an operation can be performed in which an e-mail status is displayed, including a list of any electronic documents that failed to transmit. Such an operation can be implemented in the context of a user interface, an example of which is shown in FIG. 4. Following processing and completion of the operation illustrated at block 206, the operation depicted at block 201 can be processed again.

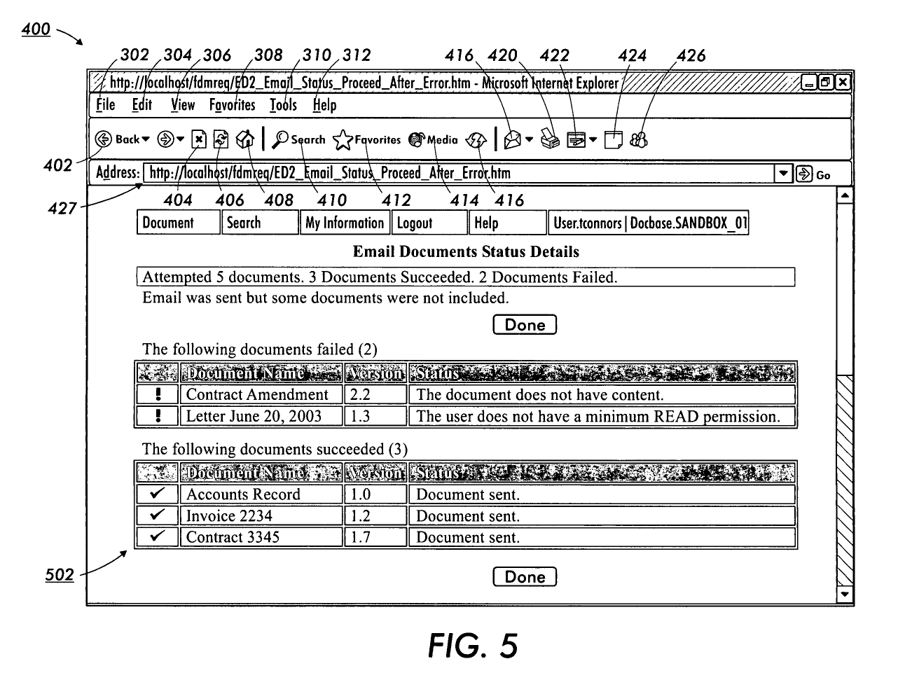

Alternatively, the operation indicated at block 216 can be implemented following the operation illustrated at block 212. In the operation depicted at block 216, e-mail status data can be displayed, including a list of any documents that failed and/or succeeded. Following completion of the operation depicted at block 216, the operation described at block 202 can be processed. Note that an example of the operation depicted at block 216 is described in further detail herein with respect to FIG. 5, which illustrates a user interface.

FIG. 3 illustrates an electronic document management user interface 300, which can be implemented in accordance with a preferred embodiment. User interface 300 can implement an e-mail operation that may be referred to as “Dialog ED-1”. User interface 300 can be implemented as a graphical user interface “Window” that generally includes a plurality of user interface functions, such as functions 302, 304, 306, 308, 310, and 312, which respectively implement “File”, “Edit” “View”, “Favorites”, “Tools” and “Help” functions that are typical of such a graphical user interface “window” environment.

User interface 300 can thus be implemented as “window,” which in applications and graphical interfaces, is typically that portion of the computer screen that can contain its own document or message. In window-based environments, such a screen can be divided and/or sub-divided into one or more “windows”, wherein each window generally possesses its own boundaries and may have different documents or optionally, a varying view of the same document. Thus, such a graphical user interface “window” can be implemented in a “windowing” environment, which may be implemented as an operating system or shell that displays for a user, particularly delineated areas of the screen known as “windows”. Note that a graphical user interface is generally a type of display format that enables a user to choose commands, start programs, and see lists of files and other options by pointing to pictorial representations (icons) and lists of menu items on the screen. Choices can generally be activated by either a keyboard or a mouse.

Window or graphical user interface 300 generally includes an area 314 in which information is displayed for the user indicating the number of electronic documents that have been selected for electronic mailing. Area 314 also provides a user input field. In order to mail the selected the documents, the user must complete the user input field or form. The user's e-mail address is generally used as a reply to the e-mail address. Required entry fields are indicated by an asterisk.

FIG. 4 illustrates an electronic document management user interface 400 with high-level e-mail status information, which can be implemented in accordance with a preferred embodiment. Note that in FIGS. 3-5, identical or similar parts or elements are generally indicated by identical reference numerals. User interface 400 can function as a “Browser” window, which includes browser features 402, 404, 406, 408, 410, 414, 416, 418, 420, 422, 424 and 426. In general, such browser features

Graphical user interface 400 also includes an area 427 dedicated to a universal resource locator (URL) address. A Web browser utilized by a graphical user interface can search specific address links. Internet services are typically accessed by specifying a unique address, or URL. The URL has two basic components, the protocol to be used and the object pathname. For example, the URL “http://www.uspto.gov” (i.e., home page for the U.S. Patent and Trademark Office) specifies a hypertext transfer protocol (http) and a pathname of the server (www.uspto.gov). The server name is associated with a unique numeric value (TCP/IP address). In the example depicted in FIG. 4, sample graphical user interface 400 (i.e., a window) is referred to by the URL “http://localhost/fdmreq/ED?_Email_Status_Proceed_After_Error.htm” (home page for the displayed web page). Thus, the information or “web page” displayed within area 428 of interface 400 is associated with the URL “http://localhost/fdmreq/ED?_Email_Status_Proceed_After_Error.htm” that is shown in field 427.

Window or graphical user interface 400 generally includes graphical user interface area 428, which provides an example of update status information concerning the e-mail operation. In area 428, for example, a notice is provided that 5 documents were attempted to be sent, and that 3 documents succeeding in being sent, but 2 documents failed. Thus, e-mail was sent, but some documents were not included in the transmission. A summary of the failed documents is provided in area 428.

FIG. 5 illustrates the electronic document management user interface 400, which displays detailed e-mail status information, in accordance with a preferred embodiment. Window or user interface 400 can include a “page” or area 402 that displays data indicating that 5 documents were attempted sent, three documents succeeded in the attempt and two documents failed. A summary of the three documents sent (i.e., “accounts record”, “invoice 2234”, and “contract 3345”) are displayed in area 502, along with two failed documents (i.e., “contract amendment” and “letter Jun. 20, 2003”).

FIGS. 1-5 illustrate a number of user configuration options that can be implemented for managing the retrieval and transmission of electronic documents via electronic mail. In general, the embodiments of FIGS. 1-5 do not represent zip and “e-mail” features, because such feature available in existing system (e.g., “right click” in “windows” for zip and e-mail operations). Instead, FIGS. 1-5 illustrate embodiments of “terminate/proceed on fault” behavior for the email operation and to send email as long as one selected document can be accessed and operated upon. Additionally, FIGS. 1-5 illustrate embodiments that result in the detailed display of each document's success and/or failure status.

In implementing a system such as system 100 described herein, a number of requirement/specification line items can be implemented and referred to by “ED” designations, wherein “ED” is an acronym for the “e-mail document”. Thus, an ED-0500 is an “e-mail document” operation, which can include a means for a deployment team or users to configure, or for a user to select, one of the following email behaviors: Terminate or Proceed. In a “terminate” operation, email is not sent if any “document related problem” is detected. In a “proceed” operation, e-mail can be sent as long as at least one “document related problem” does not exist (i.e., send email if there is at least one “document related success”). Where “document related problem” is indicated or displayed for a user, error condition related requirements can be outlined in separate requirements.

An ED-0505 operation indicates that if the “Email Document” operation is configured per ED-0500 for “Terminate”, if any document related problem is detected, the system should not attempt to send the email. An ED-0510 operation indicates that it the “Email Document” operation is configured per ED-0500 for “Proceed”, as long as there is at least one “document related success,” the system should attempt to submit the email to the specified mail server. Similarly, an ED-0514 operation indicates that if the “Email Document” operation is configured per ED-0500 for “Proceed”, if there is no “document related success,” conditions the system should not attempt to submit the email to the specified mail server. Additionally, an ED-0511 operation indicates that in the “Email Document” operation, if there were no document related errors detected and the email operation was attempted successfully, the system must inform the user via the “Email Document” Status Dialog ED-3 general message area. A General Status Message means the following: “Email was sent.”

In an ED-0490 operation, if the “Email Document” operation does not detect a “document related problem” in operating on a document, it must report a status message in an Email Document Status Dialog ED-3 document error details area. An ED-0405 operation indicates that the “Email Document” operation detects the following “document related problem” conditions and report a status message in the Email Document Status Dialog ED-3 document error details area:
Condition: The document does not have content. Document Status Message: “The document does not have content”
Condition: Retrieval and/or download of the document from the repository failed. Document Status Message: “An error occurred while the document was being retrieved from the repository.”
Condition: The user does not have sufficient permission to read the document Document Status Message: “The user does not have a minimum of READ permission.
Condition: Inclusion of document into zip failed. Document Status Message: “Could not include the document in the zip file.”
Condition: No document errors detected. Document Status Message: “Document Sent.”

By implementing embodiments disclosed herein, a number of advantages can accrue to a user or groups of users. For example, existing “zip and email” features (e.g. on Windows) only notify a user that electronics documents cannot be included and therefore requests a user to address the problem and retry. In some instances, such a system forces the user to re-select many documents and attempt the e-mail again, thereby wasting time and promoting inefficiency. A customer may then proceed with e-mailing those documents that may be emailed.

One area where the features described herein can be helpful involves “human resource” divisions of organizations and companies. Such organizations must routinely e-mail human resource related documents for a specified employee (e.g., including up to 150 documents) to legal department or 3^{rd} party partners who do not have access to a repository, such as database 124 depicted in FIG. 1. In some instances, certain documents should not be accessed or distributed per company policy or by law. Rather than remember which documents can be distributed and which cannot, the features disclosed herein can allow a repository user to select entire employee files and then choose one or more of the e-mail features described herein. Document permissions can thus be established, such that electronic documents that should not be accessible cannot be retrieved, but e-mail related operation may proceed with respect to the sending of those documents which may be accessed.

Thus, a plurality of electronic documents can be configured such that one or more of the electronic documents are subject to a user-designated restriction. The plurality of electronic documents can then be selected, in response to a user input, as an attachment to an electronic message. Thereafter, the plurality of electronic documents can be automatically and electronically transmitted as an attachment to the electronic message without one or more of the electronic documents that were subject to the user-designated restriction. In this manner a user can select an entire file and then select electronic mail features in which document permissions are established such that electronic documents which should not be accessible cannot be retrieved, but electronic mail operations can proceed in sending those documents among the group or plurality of electronic documents, which are designed as accessible.

Note that embodiments can be implemented in the context of modules. In the computer programming arts, a module can be typically implemented as a collection of routines and data structures that performs particular tasks or implements a particular abstract data type. Modules generally are composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media. An example of a suitable module, which may be implemented in accordance with embodiments of the present invention. Such modules can also be referred to as “instruction media,” which can be stored in a memory of a computer and processed via an associated microprocessor.

It can be appreciated that various other alternatives, modifications, variations, improvements, equivalents, or substantial equivalents of the teachings herein that, for example, are or may be presently unforeseen, unappreciated, or subsequently arrived at by applicants or others are also intended to be encompassed by the claims and amendments thereto.

1. A method, comprising:
configuring a plurality of electronic documents, wherein at least one electronic document among said plurality of electronic documents is subject to a user-designated restriction;
selecting said plurality of electronic documents, in response to a user input; and
automatically and electronically transmitting said plurality of electronic documents without said at least one electronic document subject to said user-designated restriction.

2. The method of claim 1 wherein said selecting said plurality of electronic documents, in response to a user input further comprises:
attaching said plurality of electronic documents to an electronic message without said at least one electronic document subject to said user-designated restriction, in response to said user input.

3. The method of claim 1 further comprising automatically generating and displaying data indicative of a transmission success or failure of at least one electronic document among said plurality of electronic documents in response to automatically and transmitting said plurality of electronic documents without said at least one electronic document subject to said user-designated restriction.

4. The method of claim 1 further comprising:
analyzing said plurality of electronic documents; and
determining if at least one document related problem exists among said plurality of electronic documents.

5. The method of claim 4 further comprising canceling transmitting said plurality of electronic documents if said at least one document related problem is identified among said plurality of electronic documents.

6. The method of claim 4 further comprising permitting transmitting said plurality of electronic documents if said at least one document related problem is not identified among said plurality of electronic documents.

7. The method of claim 6 further comprising transmitting said plurality of electronic documents to a specified mail server in response to permitting transmitting said plurality of electronic documents if said at least one document related problem is not identified among said plurality of electronic documents.

8. A method, comprising:
configuring a plurality of electronic documents, wherein at least one electronic document among said plurality of electronic documents is subject to a user-designated restriction;
attaching said plurality of electronic documents to an electronic message without said at least one electronic document subject to said user-designated restriction, in response to said user input;
automatically and electronically transmitting said plurality of electronic documents with said electronic message without said at least one electronic document subject to said user-designated restriction; and
automatically generating and displaying data indicative of a transmission success or failure of at least one electronic document among said plurality of electronic documents in response to automatically and transmitting said plurality of electronic documents without said at least one electronic document subject to said user-designated restriction

9. The method of claim 8 further comprising:
analyzing said plurality of electronic documents; and
determining if at least one document related problem exists among said plurality of electronic documents.

10. The method of claim 9 further comprising:
canceling transmitting said plurality of electronic documents if said at least one document related problem is identified among said plurality of electronic documents;
permitting transmitting said plurality of electronic documents if said at least one document related problem is not identified among said plurality of electronic documents; and
transmitting said plurality of electronic documents to a specified mail server in response to permitting transmitting said plurality of electronic documents if said at least one document related problem is not identified among said plurality of electronic documents.

11. A system, comprising:
a plurality of electronic documents configured such that at least one electronic document among said plurality of electronic documents is subject to a user-designated restriction;
instruction media residing in a computer for selecting said plurality of electronic documents, in response to a user input; and
instruction media residing in a computer for automatically and electronically transmitting said plurality of electronic documents without said at least one electronic document subject to said user-designated restriction.

12. The system of claim 11 wherein said instruction media residing in a computer for selecting said plurality of electronic documents, in response to a user input further comprises:
instruction media residing in a computer for attaching said plurality of electronic documents to an electronic message without said at least one electronic document subject to said user-designated restriction, in response to said user input.

13. The system of claim 11 further comprising instruction media residing in a computer for automatically generating and displaying data indicative of a transmission success or failure of at least one electronic document among said plurality of electronic documents in response to automatically and transmitting said plurality of electronic documents without said at least one electronic document subject to said user-designated restriction.

14. The system of claim 1 further comprising:
instruction media residing in a computer for analyzing said plurality of electronic documents; and
instruction media residing in a computer for determining if at least one document related problem exists among said plurality of electronic documents.

15. The system of claim 14 further comprising instruction media residing in a computer for canceling transmitting said plurality of electronic documents if said at least one document related problem is identified among said plurality of electronic documents.

16. The system of claim 14 further comprising instruction media residing in a computer for permitting transmitting said plurality of electronic documents if said at least one document related problem is not identified among said plurality of electronic documents.

17. The system of claim 16 further comprising instruction media residing in a computer for transmitting said plurality of electronic documents to a specified mail server in response to permitting transmitting said plurality of electronic documents if said at least one document related problem is not identified among said plurality of electronic documents.

18. The system of claim 11 wherein each of said instruction media further comprises signal-bearing media.

19. The system of claim 18 wherein said signal-bearing media comprises transmission media.

20. The system of claim 18 wherein said signal-bearing media comprises recordable media.
